(19) United States
(12) Patent Application Publication
(10) Pub. No.: US 2010/0121649 A1
(43) Pub. Date: May 13, 2010

(54) METHODS AND SYSTEMS FOR USER REGISTRATION

(76) Inventors: Liam Sean Lynch, San Jose, CA (US); Fraser MacConnell Smith, Menlo Park, CA (US); Sandeep Bhalla, San Jose, CA (US); Debora E. Aoki, Oakland, CA (US)

Correspondence Address: SCHWEGMAN, LUNDBERG & WOESSNER/EBAY, P.O. BOX 2938, MINNEAPOLIS, MN, 55402, US

(21) Appl. No.: 12/269,784

(22) Filed: Nov. 12, 2008

(51) Int. Cl. G06Q 99/00

(52) U.S. Cl. 705/1.1

(57) ABSTRACT

A method and a system to register a user include using some user information stored and provided by a third party system. For example, the user may provide an identifier associated with the third party system. The identifier may be used to retrieve the user information. The user information may be used to at least partially complete the user registration.

### TECHNICAL FIELD

The present application relates generally to the technical field of data processing and, in one specific example, to methods and systems for user registration.

### BACKGROUND

Services offered by online applications may fall into multiple tiers, with some services being available to all users while other services may only be available to registered users. A registration process may be used to enable a potential user to become a registered user. Typically, the registration process may be lengthy and may require all potential users to go through every step of the process. The lengthy registration process may discourage some potential users to register.

### BRIEF DESCRIPTION OF THE DRAWINGS

Some embodiments are illustrated by way of example and not limitation in the figures of the accompanying drawings in which:

FIG. 1A is a block diagram illustrating a registration system, in accordance with some example embodiments.

FIG. 1B is a flow diagram illustrating an example method of user registration, in accordance with some example embodiments.

FIG. 2A is a block diagram illustrating components of an alternative registration system, in accordance with some example embodiments.

FIG. 2B is a block diagram illustrating an alternative registration system, in accordance with some example embodiments.

FIG. 3 is a flow diagram illustrating an example method of user registration based on email address, in accordance with some example embodiments.

FIG. 4 is a flow diagram illustrating an example method of creating user sign in information, in accordance with some example embodiments.

FIG. 5 is a flow diagram illustrating an example method of user registration using multiple sets of registration questionnaires, in accordance with some example embodiments.

FIG. 6 is a flow diagram illustrating an example method of user registration performed by a local system and by a third party system, in accordance with some example embodiments.

FIG. 7 illustrates a network diagram depicting a system, according to an example embodiment, having client-server architecture.

FIG. 8 is a block diagram illustrating a high level view of a payment application framework, in accordance with some example embodiments.

FIGS. 9A-9B are block diagrams illustrating a high level view of various tables including a user table, in accordance with some example embodiments.

FIG. 10 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

Example methods and systems of user registration are described. In the following description, for purposes of explanation, numerous specific details are set forth in order to provide a thorough understanding of example embodiments. It will be evident, however, to one skilled in the art that the present invention may be practiced without these specific details.

As described herein, the term “a user” may be used to refer to any user who is not registered with a system. The term “a registered user” may be used to refer to any user who has completed a registration process and who is able to sign in to a system using a specific combination of user identification (userid) and password. Information associated with a user and used to register the user may be referred to as user information.

Typically, the user information may be provided by the user. For some example embodiments, at least some of the user information may be provided by a third party.

### Architecture

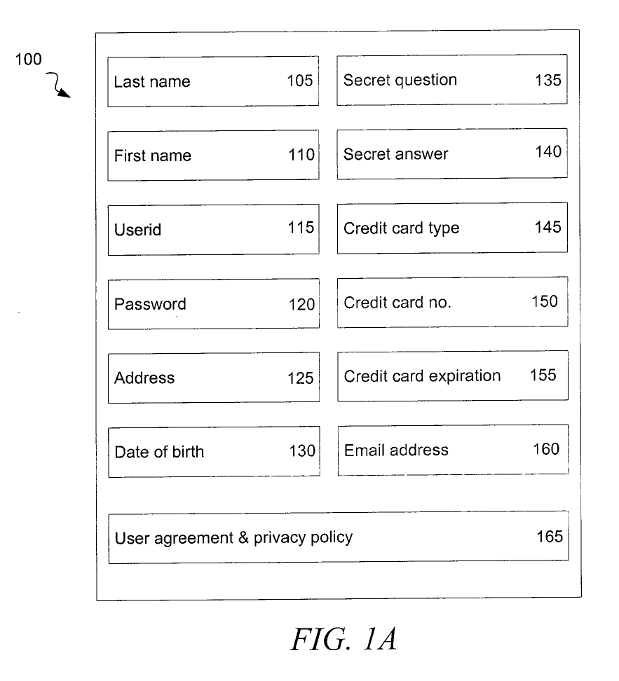

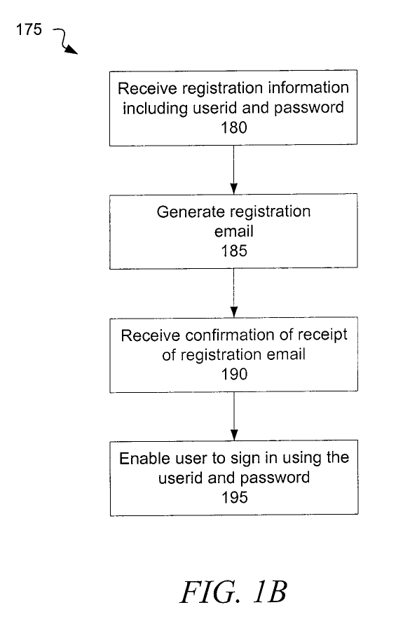

FIG. 1A is a block diagram illustrating components of a registration system, in accordance with some example embodiments. Registration system 100 may be part of a system that a user is registering with. The registration system 100 may include multiple software and/or hardware that requests, receives and processes the user information to enable the user to become a registered user.

Merely as an example, the registration system 100 may include a last name module 105 to request and receive last name information from a user. Similarly, there may be a first name module 110 to request and receive first name information, a userid module 115 to request and receive userid information, a password module 120 to request and receive password information. There may be an address module 125 to request and receive address information from the user, a date of birth module 130 to request and receive date of birth information. There may be a secret question module 135 to request and receive secret question information, a secret answer module 140 to request and receive secret answer information, a credit card type module 145 to request and receive credit card type information, a credit card number module 150 to request and receive credit card number information, and a credit card expiration module 155 to request and receive credit card expiration information. Further, there may also be a user agreement and policy module 165 to request and receive user agreement and privacy information. Two or more of the above modules may be combined to perform similar operations. Although not shown, other user information may also be requested and received by the registration system 100.

FIG. 1B is a flow diagram illustrating an example method of user registration, in accordance with some example embodiments. Flow diagram 175 may be used to register a user. At block 180, the user may interact with the registration system 100 and may provide requested user information including, for example, userid and password information. At block 185, the system may generate a registration electronic mail (email). The registration email may be sent to the user using the email address specified by the user. When the user receives the registration email, the user may need to select an activation link which confirms that the user receives the registration email, as shown in block 190. This enables the system to allow the user to sign in to the system as a registered user, as shown in block 195.

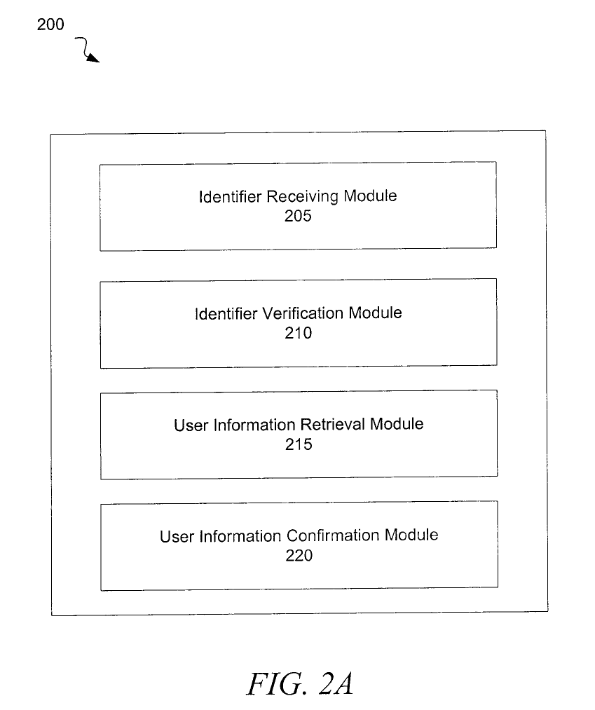

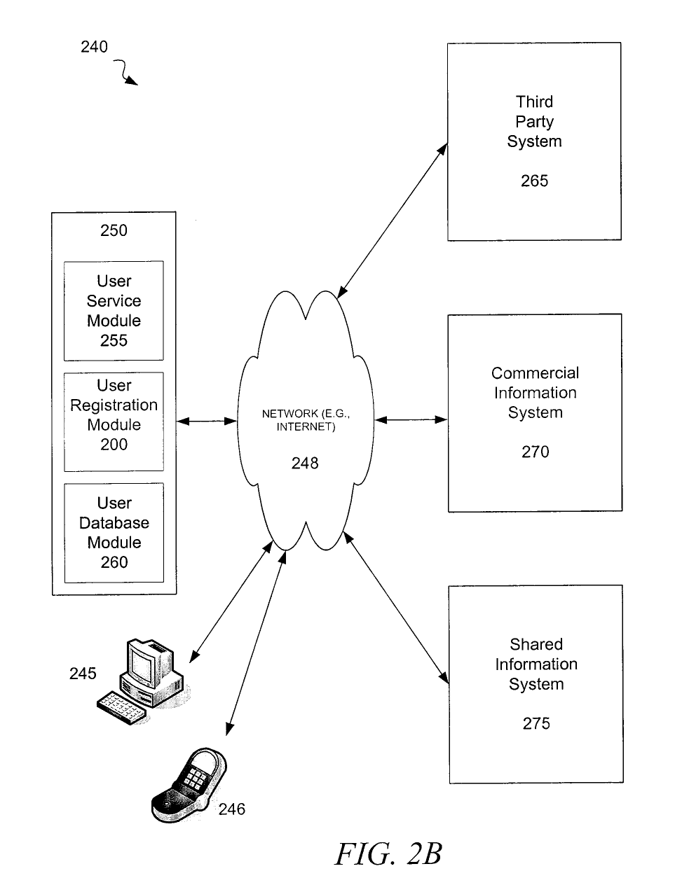

FIG. 2A is a block diagram illustrating an alternative registration system, in accordance with some example embodiments. For some example embodiments, some of the user information required to register a user may be available from a third party. The user information may be used to at least partially complete the user registration without having to request and receive from the user. Since the user information may be available from a third party, the number of operations and the number of modules described in FIGS. 1A-1B may be reduced. Registration system 200 may include an identifier receiving module 205, an identifier verification module 210, a registration information generation module 215 and a registration information confirmation module 220.

The identifier receiving module 205 may be configured to request and receive an identifier from a user. For some example embodiments, the identifier may be an email address. Other types of identifier may also be used. The identifier may have been provided to the user by a third party. For some example embodiments, the third party may store user information based on services offered to the user by the third party at a cost. For some example embodiments, the third party may have verified the user before making the services available to the user. Verification performed by the third party be financially related and may include credit rating verification, payment history verification, salary verification, assets verification, liability verification, etc. The verification may also be based on security information, confidential information, personal information, etc. Based on the verification performed by the third party, the user information stored by the third party may be considered to be reliable. Further, the user may be deemed to have certain levels of trust worthiness. As such, the user may be considered as a good candidate to become a registered user.

The third party may be any entities that the user is doing business with. For example, the third party may be a bank, a cable company, a mortgage company, credit card company, a telephone company, etc. The third party may also be a commercial entity that provides fee-based verification services. As will be shown in FIG. 2B, the third party may be associated with a third party system.

The identifier verification module 210 may be configured to verify the identifier provided by the user to determine if the identifier is associated with a third party that has previously verified the user. For some example embodiments, the user may be presented with an option to use an alternative user registration. The alternative user registration may be associated with receiving the user information from the third party. The alternative user registration may be faster than the typical user registration (as described with FIGS. 1A-1B) because the user may only need to provide some and not all of the user information.

For some example embodiments, the registration module 200 may receive the user information from the third party based on relationship or agreements with the third party. This may also be based on approval provided by the user. The user information retrieval module 215 may establish a communication with a third party and receive the user information from the third party. The user information retrieval module 215 may present the received user information to the user and may provide the user an opportunity to make any modifications. For example, the received information may include the user's first name, last name, address, and telephone number, and date of birth information.

The user information confirmation module 220 may be configured to request any other user information not available from the third party. The user information confirmation module 220 may also be configured to send a confirmation email to the user to complete the user registration.

For some example embodiments, the registration module 200 may also generate a userid and/or a password for the potential user. Alternatively, the registration module 200 may enable the user to user the same userid and password that the user has with the third party. The user may then have the option to modify the userid and password. It may be noted that operations performed by two or more of the modules described in FIG. 2A may be combined into one module.

FIG. 2B is a block diagram illustrating a registration network, in accordance with some example embodiments. Registration network 240 may include local system 250 and various third party systems. The local system 250 may be connected to network 248. The network 248 may be an Internet. A user wishing to register with the local system 250 may use client station 245 or 246. It may be noted that either or both of the client stations 245 and 246 may be connected to the network 248 using wired or wireless communication.

The local system 250 may include user service module 255 and user database module 260. The local system 250 may also include the user registration module 200. The operations of the user registration module 200 are described above. The user service module 255 may be configured to offer various network-based services to the users of the local systems 250. For example, the local system 250 may be associated with an online marketplace, and the user service module 255 may enable the users to sell items and/or to buy items. The user database module 260 may be configured to store the user information of one or more registered users and unregistered users. The user information stored by the user database module 260 may include, for example, userid, password and email address of a registered user.

The registration network 240 may include a third party system 265 which is connected to the network 248. The third party system 265 may provide user information to the local system 250. The user information provided by the third party system 265 may be used to at least partially complete the user registration for a user. For example, the third party system 265 may be associated with a cable company, a cell phone carrier company, etc. A user using a cell phone (e.g., client station 246) may be able to register with the local system 250 using an identifier (e.g., email address) provided by the carrier company (e.g., AT&T, Verizon, etc.) and using the user information stored and provided by the carrier company.

For some example embodiments, the registration network 240 may include a commercial information system 270 and/or a shared information system 275. The commercial information system 270 may be associated with a company that verifies user information and may provide the user information for a fee. The user information sold may be used to at least partially complete the user registration. A fee arrangement may be established between the local system 250 and the commercial information system 270.

The shared information system 275 may be configured such that it allows member systems to share and exchange user information. The shared and exchanged user information may then be used to at least partially complete the user registration. Depending on the implementation, a combination of one or more of the third party system 265, commercial information system 270, and shared information system 275 may be used. It may be noted that each of the systems 265-270 may be referred to generally as a third party system.

### Flow Diagrams

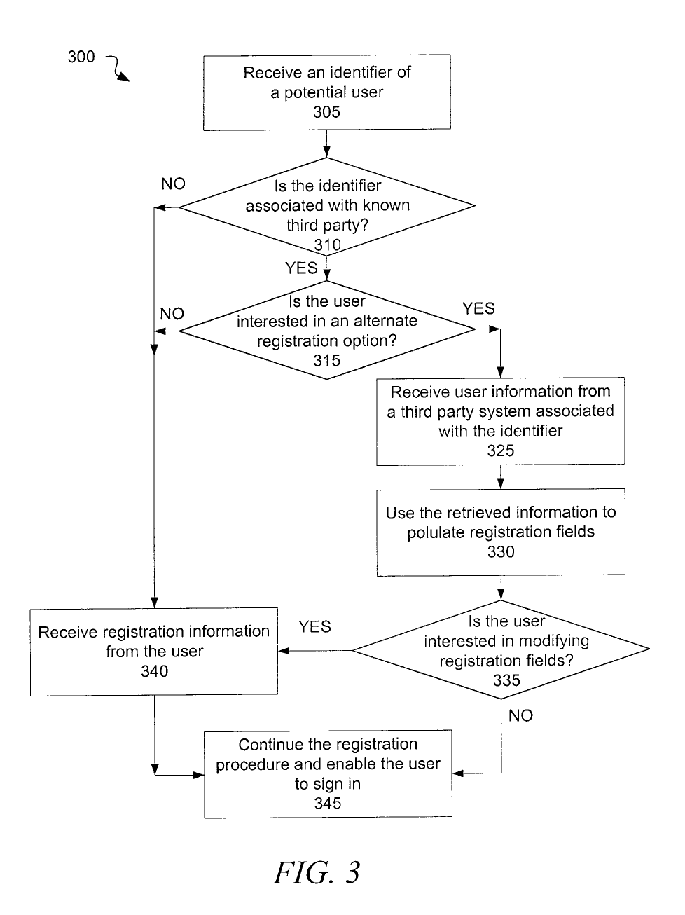

FIG. 3 is a flow diagram illustrating an example method of user registration, in accordance with some example embodiments. Merely as an example, the identifier is an email address. The method may be performed by a system such as, for example, the local system 250 described in FIG. 2B. At block 305, an identifier is received from a user. For some example embodiments, the identifier may be an email address. At block 310, it is determined if the email address is associated with a known third party that may be able to provide the user information. From block 310, if the email address is not associated with a known third party, the flow continues to block 340 where the user information is received from the user. From block 310, if the email address is associated with a known third party, the flow continues to block 315 where it is determined if the user is interested in using an alternative user registration. It may be noted that the determination performed in block 315 may be related to whether the potential user provides approval to have the user information retrieved from the third party. A user may prefer to provide the user information even though some of the same user information may be retrieved from the third party.

From block 315, if the user is not interested, the flow continues to block 340. However, if the user is interested, the flow continues to block 325 where user information may be received from the third party. At block 330, the received user information may be used to complete the user registration.

At block 335, it is determined if the user wants to modify the information received from the third party. If modification is desired by the user, the flow may continue to block 340. If no modification is desired, the flow may continue to block 345. At block 345, the local system may enable the user to sign in.

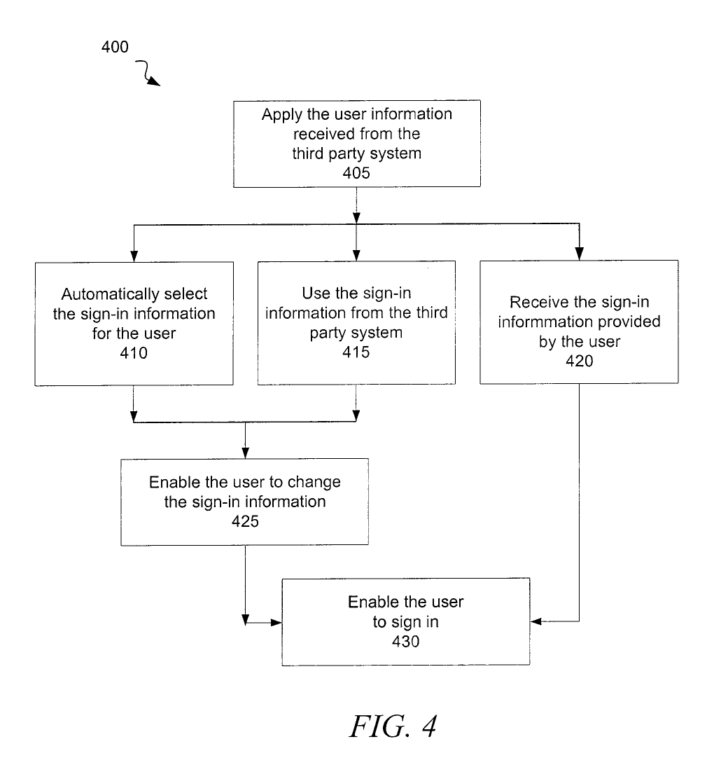

FIG. 4 is a flow diagram illustrating an example method of creating user sign in information, in accordance with some example embodiments. The flow may start at block 405 where the user information received from the third party may be applied by the user registration module 200. From block 405, the flow may continue to only one of the blocks 410-420 where a different approach to determining the userid and password may be used. At block 410, the userid and password are automatically assigned to the user. At block 415, the userid and password may be the same as used with the third party system. At block 420, the userid and password are specified by the user. For some example embodiments, if the operations associated with the blocks 410 or 415 are implemented, the user may be provided an opportunity to modify the userid and password. At block 430, the userid and password may be used by the user to sign in to the local system 250. Regardless of the approach used to provide the userid and password, the user may subsequently have options to modify either one.

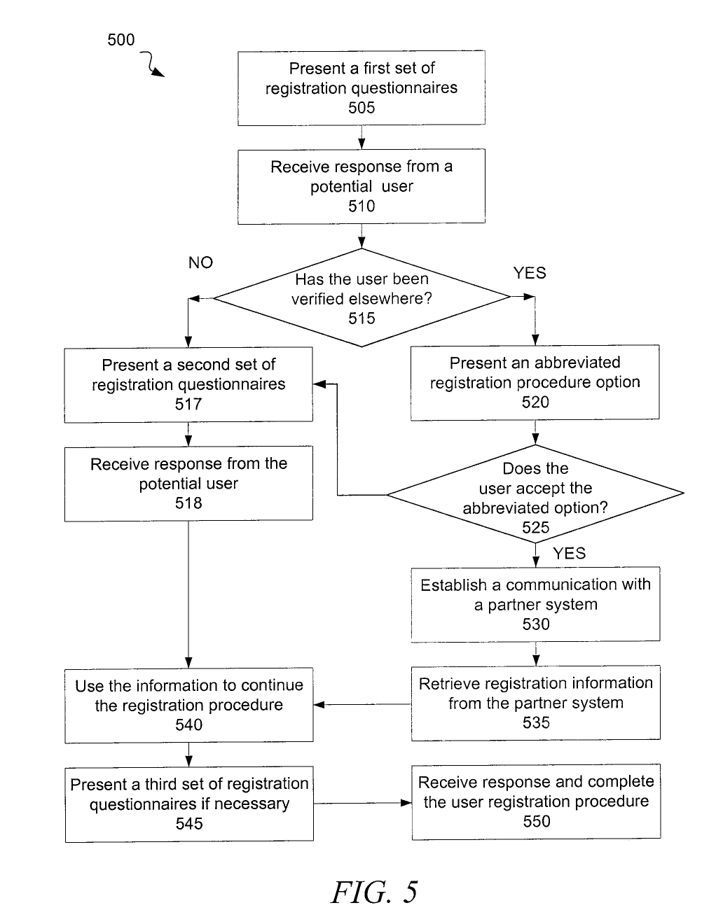

FIG. 5 is a flow diagram illustrating an example method of user registration using multiple sets of registration questionnaires, in accordance with some example embodiments. Flow diagram 500 may vary slightly from the flow diagram 300 in that user information may be divided into three different groups. A first group of user information may be provided by the user and may be used to determine if the user is going to provide a second group of user information. This is illustrated in blocks 505, 510 and 515. If the second group of user information can be provided by a third party and not by the user the user may be asked if that option is acceptable, as shown in blocks 520 and 525. If the user approves, then the second group of user information may be retrieved from the third party, as shown in blocks 530 and 535. If the user does not approve, the second group of user information is provided by the user, as shown in blocks 517 and 518. At block 540, the second group of user information provided by the user or received from the third party is used to move the user registration forward. At blocks 545 and 550, a third group of user information may be provided by the user and may be used to complete the user registration. The third group of user information may include, for example, information related to user agreement and privacy policy.

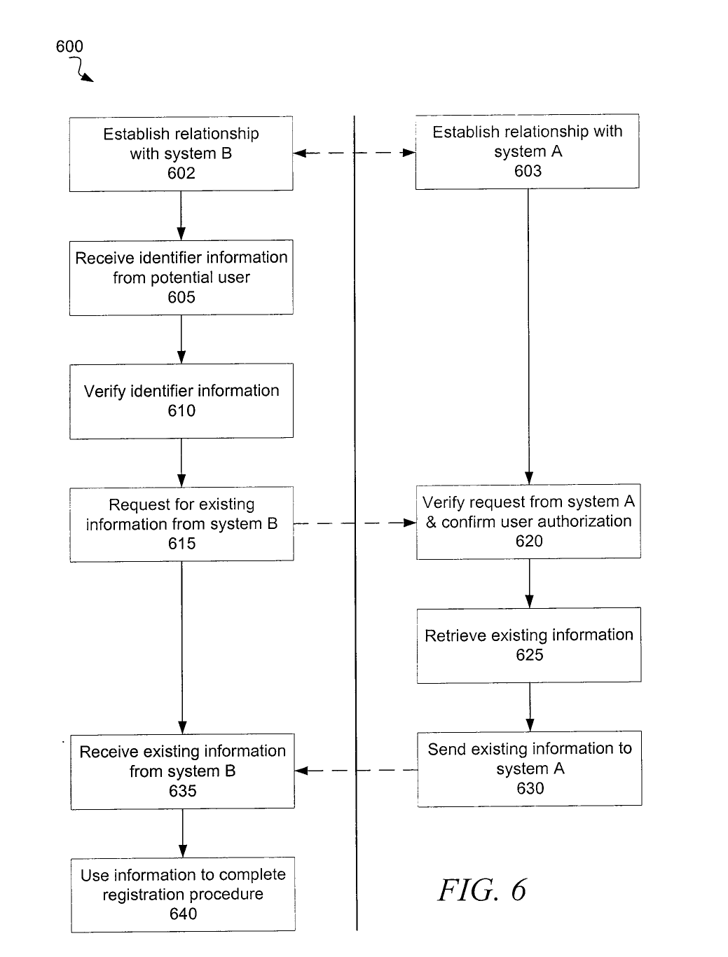

FIG. 6 is a flow diagram illustrating another example method of user registration, in accordance with some example embodiments. Flow diagram 600 may illustrate two parallel tracks of operations performed by a local system and by a third party system. The left side of the flow diagram 600 illustrates operations performed by a local system. The right side of the flow diagram 600 illustrates operations performed by a third-party system. The dotted lines between blocks 602 and 603 is used to illustrate that relationship may need to be established between the local system and the third party system. The dotted lines between blocks 615 and 620 and blocks 630 and 635 are used to illustrate communications and data transfer between the local system and the third party system.

Blocks 605, 610 and 615 illustrate receiving the identifier from the user, verifying the identifier, and requesting for the user information from the third party system. Blocks 620, 625 and 630 illustrate the third party system receiving the request from the local system, retrieving the user information, and sending the user information to the local system. Blocks 635 and 640 illustrate the local system receiving the user information from the third party system and use the user information to at least partially complete the user registration.

### Platform Architecture

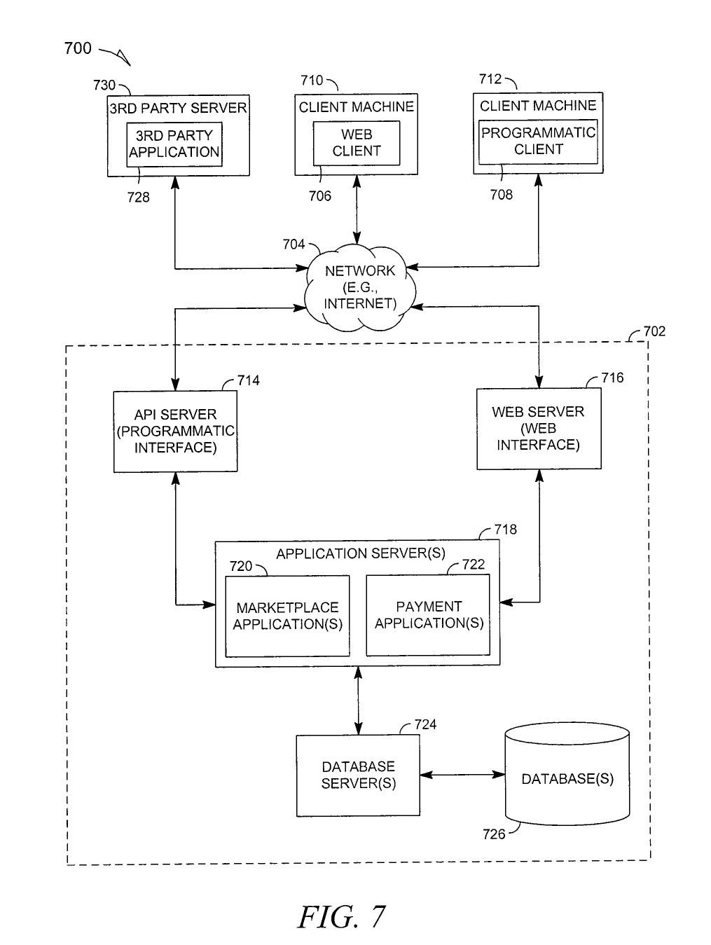

FIG. 7 is a network diagram depicting a client-server system 700, within which one example embodiment may be deployed. A networked system 702, in the example forms of a network-based marketplace or publication system, provides server-side functionality, via a network 704 (e.g., the Internet or Wide Area Network (WAN)) to one or more clients. FIG. 7 illustrates, for example, a web client 706 (e.g., a browser, such as the Internet Explorer browser developed by Microsoft Corporation of Redmond, Wash. State), and a programmatic client 708 executing on respective client machines 710 and 712.

An Application Program Interface (API) server 714 and a web server 716 are coupled to, and provide programmatic and web interfaces respectively to, one or more application servers 718. The application servers 718 host one or more marketplace applications 720 and payment applications 722. The application servers 718 are, in turn, shown to be coupled to one or more databases servers 724 that facilitate access to one or more databases 726.

The marketplace applications 720 may provide a number of marketplace functions and services to users that access the networked system 702. The payment applications 722 may likewise provide a number of payment services and functions to users. The payment applications 722 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 720. While the marketplace and payment applications 720 and 722 are shown in FIG. 7 to both form part of the networked system 702, it will be appreciated that, in alternative embodiments, the payment applications 722 may form part of a payment service that is separate and distinct from the networked system 702.

Further, while the system 700 shown in FIG. 7 employs a client-server architecture, the present invention is of course not limited to such an architecture, and could equally well find application in a distributed, or peer-to-peer, architecture system, for example. The various marketplace and payment applications 720 and 722 could also be implemented as standalone software programs, which do not necessarily have networking capabilities.

The web client 706 accesses the various marketplace and payment applications 720 and 722 via the web interface supported by the web server 716. Similarly, the programmatic client 708 accesses the various services and functions provided by the marketplace and payment applications 720 and 722 via the programmatic interface provided by the API server 714. The programmatic client 708 may, for example, be a seller application (e.g., the TurboLister application developed by eBay Inc., of San Jose, Calif.) to enable sellers to author and manage listings on the networked system 702 in an off-line manner, and to perform batch-mode communications between the programmatic client 708 and the networked system 702.

FIG. 7 also illustrates a third party application 728, executing on a third party server machine 730, as having programmatic access to the networked system 702 via the programmatic interface provided by the API server 714. For example, the third party application 728 may, utilizing information retrieved from the networked system 702, support one or more features or functions on a website hosted by the third party. The third party website may, for example, provide one or more promotional, marketplace or payment functions that are supported by the relevant applications of the networked system 702.

### Marketplace Applications

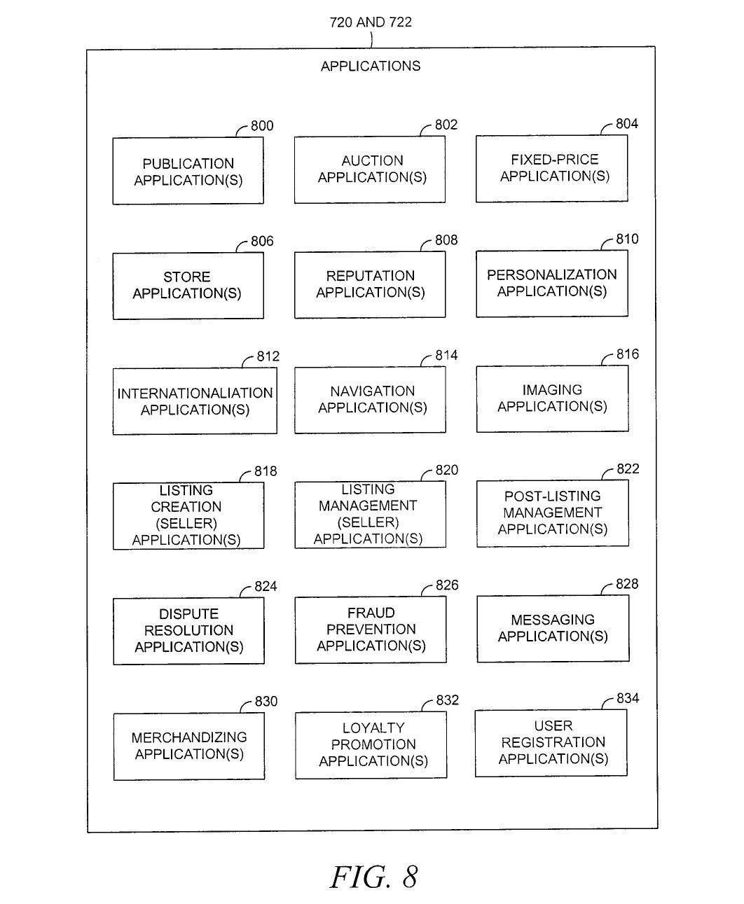

FIG. 8 is a block diagram illustrating multiple applications 720 and 722 that, in one example embodiment, are provided as part of the networked system 702. The applications 720 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 726 via the database servers 728.

The networked system 702 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 720 are shown to include at least one publication application 800 and one or more auction applications 802 which support auction-format listing and price setting mechanisms (e.g., English, Dutch, Vickrey, Chinese, Double, Reverse auctions etc.). The various auction applications 802 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 804 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 806 allow a seller to group listings within a “virtual” store, which may be branded and otherwise personalized by and for the seller. Such a virtual store may also offer promotions, incentives and features that are specific and personalized to a relevant seller.

Reputation applications 808 allow users that transact, utilizing the networked system 702, to establish, build and maintain reputations, which may be made available and published to potential trading partners. Consider that where, for example, the networked system 702 supports person-to-person trading, users may otherwise have no history or other reference information whereby the trustworthiness and credibility of potential trading partners may be assessed. The reputation applications 808 allow a user, for example through feedback provided by other transaction partners, to establish a reputation within the networked system 702 over time. Other potential trading partners may then reference such a reputation for the purposes of assessing credibility and trustworthiness.

Personalization applications 810 allow users of the networked system 702 to personalize various aspects of their interactions with the networked system 702. For example a user may, utilizing an appropriate personalization application 810, create a personalized reference page at which information regarding transactions to which the user is (or has been) a party may be viewed. Further, a personalization application 810 may enable a user to personalize listings and other aspects of their interactions with the networked system 702 and other parties.

The networked system 702 may support a number of marketplaces that are customized, for example, for specific geographic regions. A version of the networked system 702 may be customized for the United Kingdom, whereas another version of the networked system 702 may be customized for the United States. Each of these versions may operate as an independent marketplace, or may be customized (or internationalized) presentations of a common underlying marketplace. The networked system 702 may accordingly include a number of internationalization applications 812 that customize information (and/or the presentation of information) by the networked system 702 according to predetermined criteria (e.g., geographic, demographic or marketplace criteria). For example, the internationalization applications 812 may be used to support the customization of information for a number of regional websites that are operated by the networked system 702 and that are accessible via respective web servers 716.

Navigation of the networked system 702 may be facilitated by one or more navigation applications 814. For example, a search application (as an example of a navigation application) may enable key word searches of listings published via the networked system 702. A browse application may allow users to browse various category, catalogue, or inventory data structures according to which listings may be classified within the networked system 702. Various other navigation applications may be provided to supplement the search and browsing applications.

In order to make listings, available via the networked system 702, as visually informing and attractive as possible, the marketplace applications 720 may include one or more imaging applications 816 utilizing which users may upload images for inclusion within listings. An imaging application 816 also operates to incorporate images within viewed listings. The imaging applications 816 may also support one or more promotional features, such as image galleries that are presented to potential buyers. For example, sellers may pay an additional fee to have an image included within a gallery of images for promoted items.

Listing creation applications 818 allow sellers conveniently to author listings pertaining to goods or services that they wish to transact via the networked system 702, and listing management applications 820 allow sellers to manage such listings. Specifically, where a particular seller has authored and/or published a large number of listings, the management of such listings may present a challenge. The listing management applications 820 provide a number of features (e.g., auto-relisting, inventory level monitors, etc.) to assist the seller in managing such listings. One or more post-listing management applications 822 also assist sellers with a number of activities that typically occur post-listing. For example, upon completion of an auction facilitated by one or more auction applications 802, a seller may wish to leave feedback regarding a particular buyer. To this end, a post-listing management application 822 may provide an interface to one or more reputation applications 808, so as to allow the seller conveniently to provide feedback regarding multiple buyers to the reputation applications 808.

Dispute resolution applications 824 provide mechanisms whereby disputes arising between transacting parties may be resolved. For example, the dispute resolution applications 824 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 826 implement fraud detection and prevention mechanisms to reduce the occurrence of fraud within the networked system 702.

Messaging applications 828 are responsible for the generation and delivery of messages to users of the networked system 702, such messages for example advising users regarding the status of listings at the networked system 702 (e.g., providing “outbid” notices to bidders during an auction process or to provide promotional and merchandising information to users). Respective messaging applications 828 may utilize any number of message delivery networks and platforms to deliver messages to users. For example, messaging applications 828 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 830 support various merchandising functions that are made available to sellers to enable sellers to increase sales via the networked system 702. The merchandising applications 80 also operate the various merchandising features that may be invoked by sellers, and may monitor and track the success of merchandising strategies employed by sellers.

The networked system 702 itself, or one or more parties that transact via the networked system 702, may operate loyalty programs that are supported by one or more loyalty/promotions applications 832. For example, a buyer may earn loyalty or promotions points for each transaction established and/or concluded with a particular seller, and the buyer may be offered a reward for which accumulated loyalty points can be redeemed.

User registration applications 834 are responsible for the interaction with the user and with a third party system to complete the user registration. The user registration applications 834 may perform various registering operations including, for example, verifying an identifier provided by the user, communicating with a third party system, receiving user information provided by the third party system, and processing the user information received from the user and from the third party system. The user applications 834 may store the user information in the database 726 which may utilize one or more user tables to store the user information.

### Data Structures

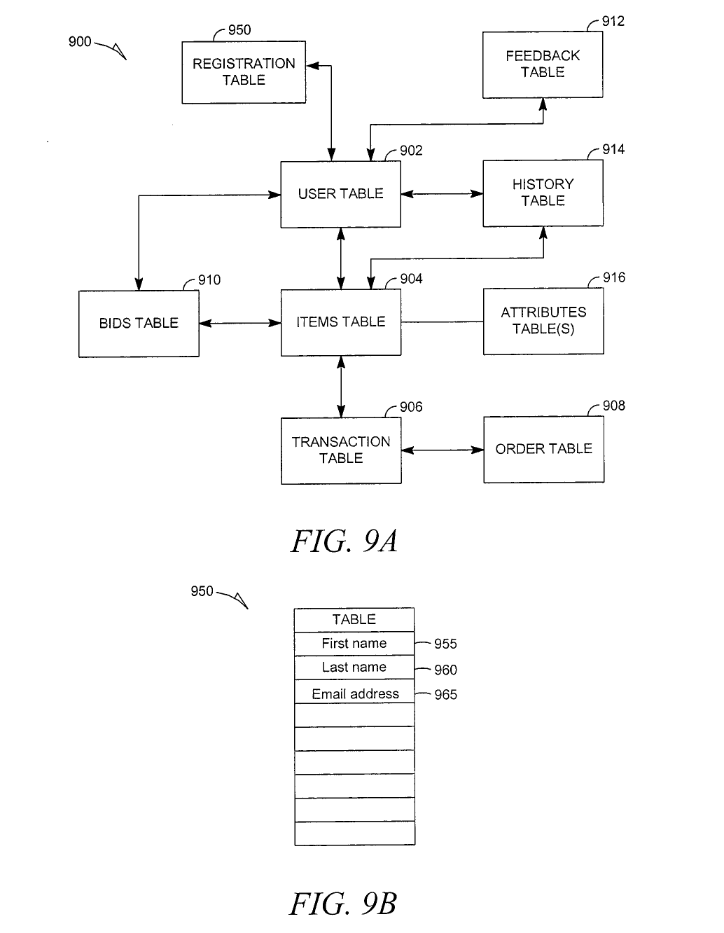

FIG. 9A is a high-level entity-relationship diagram, illustrating various tables 900 that may be maintained within the databases 726, and that are utilized by and support the applications 720 and 722. A user table 902 contains a record for each registered user of the networked system 702, and may include identifier, address and financial instrument information pertaining to each such registered user. A user may operate as a seller, a buyer, or both, within the networked system 702. In one example embodiment, a buyer may be a user that has accumulated value (e.g., commercial or proprietary currency), and is accordingly able to exchange the accumulated value for items that are offered for sale by the networked system 702.

The user table 902 may be associated with the user registration applications 834 described in FIG. 8 and may store the user information provided by the user and the user information provided by a third party system.

The tables 900 also include an items table 904 in which are maintained item records for goods and services that are available to be, or have been, transacted via the networked system 702. Each item record within the items table 904 may furthermore be linked to one or more user records within the user table 902, so as to associate a seller and one or more actual or potential buyers with each item record.

A transaction table 906 contains a record for each transaction (e.g., a purchase or sale transaction) pertaining to items for which records exist within the items table 904.

An order table 908 is populated with order records, each order record being associated with an order. Each order, in turn, may be with respect to one or more transactions for which records exist within the transaction table 906.

Bid records within a bids table 910 each relate to a bid received at the networked system 702 in connection with an auction-format listing supported by an auction application 802. A feedback table 912 is utilized by one or more reputation applications 808, in one example embodiment, to construct and maintain reputation information concerning users. A history table 914 maintains a history of transactions to which a user has been a party. One or more attributes tables 916 record attribute information pertaining to items for which records exist within the items table 904. Considering only a single example of such an attribute, the attributes tables 916 may indicate a currency attribute associated with a particular item, the currency attribute identifying the currency of a price for the relevant item as specified in by a seller. Registration table 950 includes user information that is either provided by the user or information retrieved from a third party system.

FIG. 9B provides further details regarding a user registration table that is shown in FIG. 9A to be maintained within the databases 726. As illustrated, user table 950 may include multiple fields. Each of the fields may be associated with some user registration information such as, for example, first name 955, last name 960, and email address 965. As described above, some of the user information stored in the user registration table 950 may be provided by the user while some may be provided by a third party.

### Computer Systems

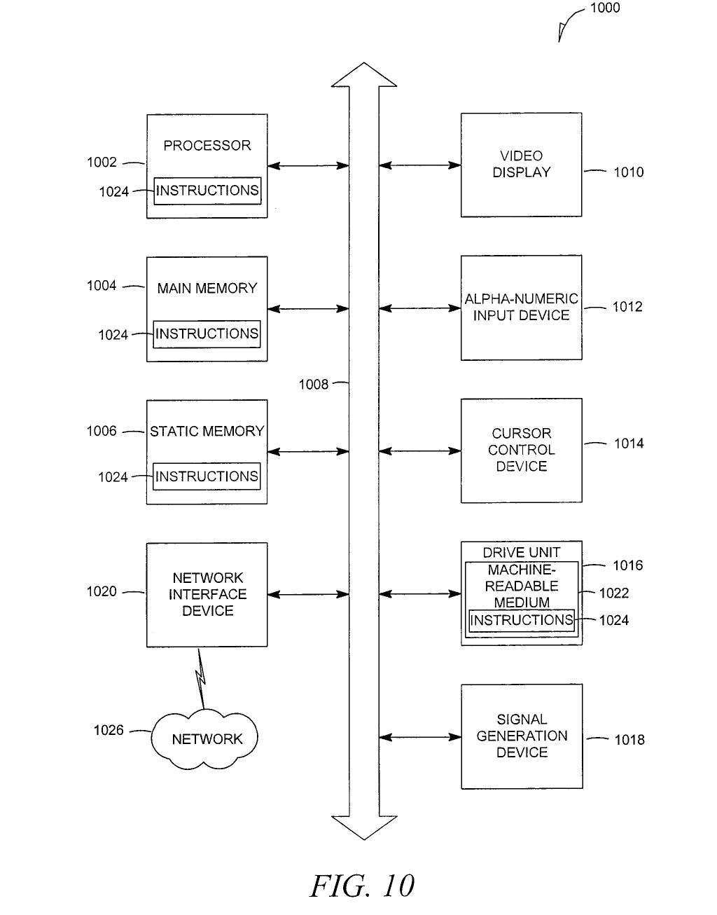

FIG. 10 shows a diagrammatic representation of machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions (e.g., software 924) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to enable user registration have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for user registration comprising:
a processor;
a user registration module coupled to the processor and configured to receive an identifier from a user to perform a user registration; and
a communication module coupled to the user registration module and configured to receive user information from the third party system based on the identifier, wherein the user information received from the third party system is used by the user registration module to at least partially complete the user registration.

2. The system of claim 1, wherein the identifier is received from the user via a mobile device associated with the user.

3. The system of claim 1, wherein the identifier is an electronic mail (email) address.

4. The system of claim 1, wherein the identifier is provided by the third party system to the user.

5. The system of claim 4, wherein the user registration module is configured to verify that the identifier is associated with the third party system and to request for the user information from the third party system based on the identifier.

6. The system of claim 5, wherein the user information is received from the third party system based on an agreement established with the third party system.

7. The system of claim 5, wherein the agreement is a fee-based agreement.

8. The system of claim 5, wherein the user information is received from the third party based on an approval provided by the user.

9. A method of user registration comprising:
receiving an identifier from a user for a user registration;
providing the user an option to use a first registration path based on the identifier;
based on to the user accepting the option to use the first registration path, communicating with a third party system to receive user information based on the identifier; and
based on the user not accepting the option to use the first registration path, requiring the user to provide the user information based on a second registration path.

10. The method of claim 9, wherein the identifier received from the user is provided to the user by the third party system.

11. The method of claim 10, wherein the third party system stores the user information based on agreement with the user.

12. The method of claim 10, further comprising:
establishing a relationship with the third party system to enable receiving the user information from the third party system.

13. The method of claim 9, wherein the second registration path involves more interaction with the user than the first registration path.

14. The method of claim 9, wherein the identifier is received from the user via a wireless communication.

15. The method of claim 14, wherein the identifier is received from the user via a mobile device associated with the user.

16. The method of claim 9, further comprising:
providing the user an option to modify the user information received from the third party system.

17. A method of user registration comprising:
receiving a request from a user to become a registered user;
requiring the user to provide an identifier associated with a third party system, the third party system having verified the user and storing user information;
requesting for the user information from the third party system based on the identifier; and
registering the user based on at least the user information received from the third party system.

18. The method of claim 17, wherein the third party system has verified the user based on financial information provided by the user.

19. The method of claim 17, wherein the third party system has verified the user based on confidential information provided by the user.

20. The method of claim 17, wherein the registering of the user is further based on user information provided by the user in addition to the user information received from the third party system.

21. The method of claim 17, further comprising:
receiving an approval from the user to request for the user information from the third party system.

22. A computer readable storage medium storing instructions that, when executed by a computer system, cause the computer system to perform the computer-implemented method of user registration, the method comprising:
receiving an identifier from a user during a user registration; and
when the identifier is associated with a third party system that has verified the user, requesting the user to provide an approval to retrieve user information from the third party system;
responsive to receiving the approval from the user, communicating with the third party system, providing the identifier to third party system, and receiving the user information from the third party system.

23. The computer readable medium of claim 22, further comprising:
using the user information received from the third party system to at least partially completing the user registration.

24. The computer readable medium of claim 22, wherein the identifier is received from the user via a mobile device, and wherein the user registration is completed based on the user using the mobile device.

25. A system for user registration comprising:
means for receiving an identifier from a user to perform a user registration;
means for receiving at least some user information from a third party system associated with the identifier; and
means for completing the user registration based at least on user information provided by the user or the user information received from the third party system.

26. The system of claim 25, further comprising means for enabling the user to modify the user information received from the third party system.

27. The system of claim 25, further comprising means for enabling the user to prevent receiving the user information from the third party system.
